(19) United States
(12) Patent Application Publication
(10) Pub. No.: US 2002/0062363 A1
(43) Pub. Date: May 23, 2002

(54) ONE-TOUCH SYSTEM FOR SENDING ELECTRONIC MAIL AND FACSIMILES FROM A FAX MACHINE

(76) Inventors: JOE G. NAYLOR, SAN FRANCISCO, CA (US); EDWARD R. PRINCE III, SAN FRANCISCO, CA (US); JOSH A. MAILMAN, CUPERTINO, CA (US)

Correspondence Address: FARZAD E. AMINI, BLAKELY SOKOLOFF TAYLOR, & ZAFMAN LLP, 12400 WILSHIRE BOULEVARD, 7TH FL., LOS ANGELES, CA, 90024, US

(21) Appl. No.: 09/187,332

(22) Filed: Nov. 6, 1998

(51) Int. Cl. G06F 15/16; G06F 15/173

(52) U.S. Cl. 709/223; 709/206

(57) ABSTRACT

This invention relates to a system which has a combined facsimile and electronic mail capability. The user stores fax telephone numbers and corresponding e-mail addresses into a fax machine. When the user activates the system, the fax machine sends both a fax and an e-mail to the intended recipient.

### BACKGROUND OF THE INVENTION

1. Technical Field

This invention relates to facsimile (fax) machines, and more particularly, to a fax machine capable of transmitting a fax and electronic mail (e-mail) to an intended recipient with the touch of a single control button on the facsimile machine.

2. Background Art

Facsimile (fax) machines are popular mechanisms for the transmission of text and graphics. They are relatively easy to use and inexpensive to purchase, and transmission by fax machine is fast and cost effective. Fax machines also can transmit over ordinary telephone lines. Moreover, the paper input and output of most fax machines appeals to those who prefer paper copies of documents and are not comfortable with transmitting and receiving information by way of computer.

For those who are comfortable with computers, electronic mail (e-mail) is an even more expedient way of transmitting information. Documents which are created using a computer, or otherwise imported, can be transmitted, received and reviewed without generation of a paper copy if compatible viewing software is available. The increasing use of wide area networks (WANs), such as the Internet, makes e-mail even more useful by allowing simultaneous transmission of data to a much wider group of recipients.

Traditionally, facsimile machines and electronic mail devices have for the most part been thought of as separate, with facsimile type communication being performed by a specialized fax machine and e-mail communications being performed by a general purpose desktop computer equipped with a modem and a connection to the Internet.

In many instances it may desirable for a party to send both faxes and electronic mail to a recipient. Such is the case, for instance, when getting a message to a person is very important. Sometimes receiving fax machines will run out of paper, become jammed or in some other way become inoperative. They will remain so until serviced by someone on the receiving end who becomes aware of the fax machine's inoperative state. Furthermore, a fax machine is generally unattended and received documents may well sit in the fax machine until someone discovers them much after they have been transmitted and received. In large companies it often takes a long time for a received fax to get to the intended recipient. An incoming fax will come into a centralized fax machine and be routed through the company's mail room. As a result it may take several days for the document to be delivered to the intended receiving party.

Although faxing information has its drawbacks, transmission by electronic mail has its own disadvantages. In most cases electronic mail will not be received until the recipient decides to check his e-mail. This usually involves logging into the appropriate software program to receive the mail. Some people do not check their e-mail for days or even weeks, if ever. Therefore, the intended recipient of the e-mail may not see it for a very long time, or the document may never be viewed by the intended recipient at all.

Sending both faxes and electronic mail to a recipient is therefore desirable to increase the odds of timely receipt of information. However, in the past this has normally required that the sender place the document into a fax machine, enter the recipient(s) fax telephone number into the fax device, and then transmit the document via facsimile. The sender would then have to prepare the document in electronic mail format on a computer, enter appropriate e-mail addresses and then transmit the document via electronic mail. This process of entering the same data into two devices is very time-consuming and therefore expensive.

Furthermore, although personal computers equipped with fax modems have been used in the past to send both faxes and e-mails, such operations are not always easy and often require specialized software for both e-mail and fax functions and knowledge thereof. Additionally, using a computer to send both electronic mail and faxes typically requires that the user import data and operate separate fax and e-mail software programs to transmit a document both by fax and by e-mail.

Thus, there is a need for an improved system and process that allows a user to send both faxes and e-mails without having to use both a fax machine and a personal computer (or just the computer if it is equipped with the necessary hardware and software). In addition, to save time, it would be desirable for the faxes and e-mails to be sent in response to a single command from the user. Such an improved system would provide major advancements in functionality and practicality over the present technology.

### SUMMARY

The present invention overcomes the common problems and disadvantages of prior fax and electronic mail systems with a system that allows faxes and e-mails to be sent from a fax machine with a touch of a single actuator on the machine.

Specifically, this transfer of electronic mail and facsimiles from the facsimile machine is accomplished by a user who enters a facsimile telephone number and an electronic mail address corresponding to the same recipient and places a document to be transmitted into the facsimile machine. The facsimile telephone number and electronic mail address are stored in a memory location in the memory of the facsimile machine, and associated with an actuator disposed on the facsimile machine. This actuator can be a control button or switch, or the like. The transmission of the facsimile to the facsimile telephone number and the electronic mail to the electronic mail address is initiated by the user activating the aforementioned control button or switch The faxes and e-mails can be transmitted in a variety of ways. For instance, the fax machine could interface with both a wide area network (WAN), such as the Internet, and various other fax machines via a server. The server would respond to requests and commands from the transmitting fax machine. Specifically, the server would receive the data transmission from the fax machine and employ user-specified information, which has been included in the data to determine where to forward the email and fax to the intended recipient. Accordingly, this user-specified data includes the fax telephone number and e-mail address of the recipient. Alternately, the fax machine could transmit the desired data directly to the recipient via conventional faxing methods, while the e-mail is transmitted to the recipient via the server. Yet another method of transmitting both a fax and an e-mail to a recipient would be to use the fax machines conventional faxing capabilities to send the desired fax, and employing an on-board connection to the Internet or other WAN to send the e-mail version of the data to the recipient.

In addition to the just described benefits, other objectives and advantages of the present invention will become apparent from the detailed description which follows hereinafter when taken in conjunction with the drawing figures which accompany it.

### DESCRIPTION OF THE DRAWINGS

The specific features, aspects, and advantages of the present invention will become better understood with regard to the following description, appended claims, and accompanying drawings where:

FIG. 1 is the schematic illustration of a facsimile machine.

FIG. 2 is a flowchart outlining a process for entering and storing data into a fax machine and transmitting a document via both fax and e-mail methods.

FIG. 3 is schematic illustration of a fax machine coupled to communicate with remote communications devices such as a wide area network and numerous fax machines through a server.

FIG. 4 is schematic illustration of a fax machine coupled to communicate directly via its own Internet and fax connections with remote communications devices such as a wide area network and numerous fax machines.

FIG. 5 is a schematic illustration of a fax machine that is coupled to communicate directly via a direct fax connection to other fax machines and that uses a server to send electronic mail.

### DETAILED DESCRIPTION OF THE PREFERRED EMBODIMENTS

In the following description of the preferred embodiments of the present invention, reference is made to the accompanying drawings which form a part hereof, and in which is shown by way of illustration specific embodiments in which the invention may be practiced. It is understood that other embodiments may be utilized and structural changes may be made without departing from the scope of the present invention.

In accordance with the present invention, fax telephone numbers and companion electronic mail addresses (electronic mail addresses that designate the same recipients as the fax telephone numbers) are stored in a fax machine. The user enters the appropriate fax numbers and corresponding electronic mail addresses into the fax machine's memory. Each pair of fax numbers and e-mail addresses is associated with a particular actuator on the fax machine. A document can then be scanned into the fax machine and transmitted both via e-mail and via fax to the intended recipient.

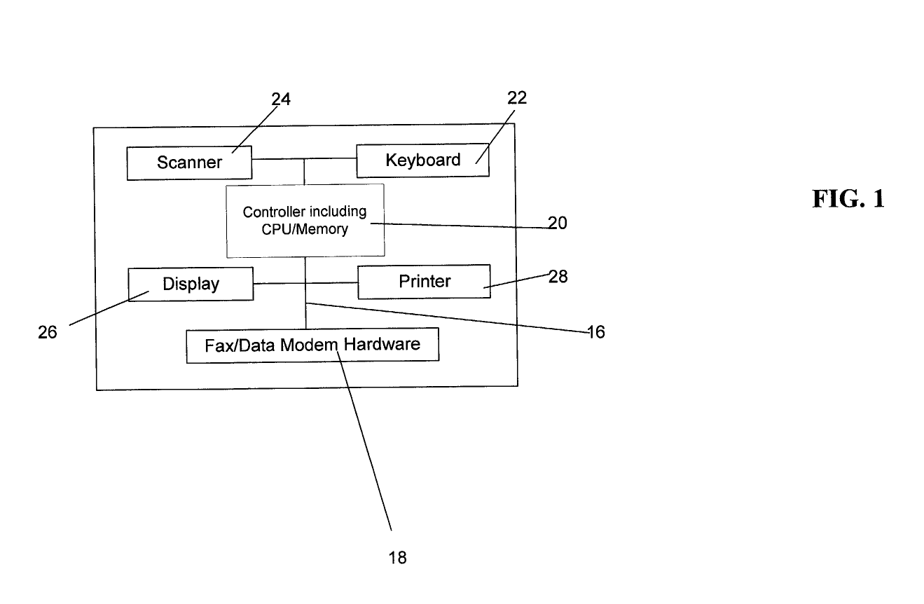

FIG. 1 is a block diagram providing an overview of one embodiment of the system according to the present invention. This configuration has a fax machine 10 with a controller 20 having a central processing unit (CPU) and memory. The fax machine also has a scanner 24, keyboard 22, display 26 and printer 28. These components are coupled together through a bus 16. The bus 16 may carry data signals, control signals and power to the various components in the fax machine 10. The scanner 24 receives a document to be transmitted and generates digital data indicative of the information contained in the document. The keyboard 22 is preferably configured to allow for the entry of alphabetic and numeric characters, and for the entry of commands to control the operation of the fax machine. For example, the keyboard 22 allows entry of destination identification information (e.g. telephone numbers and corresponding e-mail addresses) and control keys which initiate transmission. The memory, in which all destination identifiers are stored, may include Random Access Memory (RAM) and Read Only Memory (ROM). The fax modem hardware 18 includes standard hardware to physically transmit and receive signals over the phone line 29.

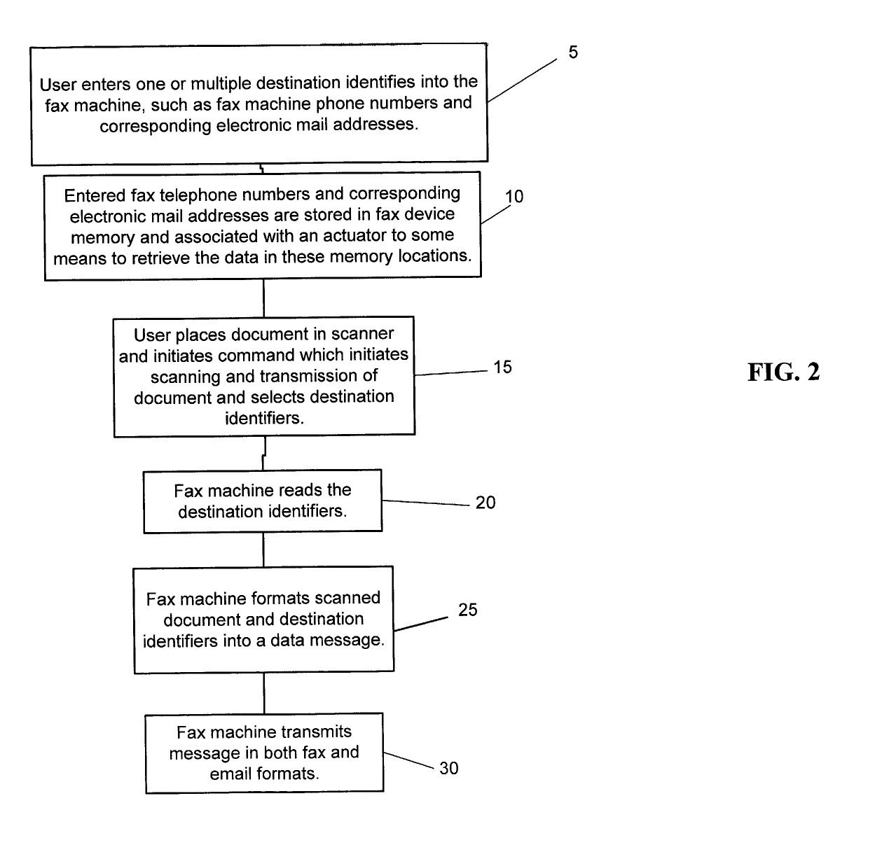

FIG. 2 presents a flowchart outlining the functions performed as part of the present invention to store and transmit information in accordance with fax and e-mail transmission protocol. As shown in FIG. 2, a user wishing to transmit a document via fax and e-mail, first enters and stores one or multiple destination identifiers into the fax machine's keyboard as shown in step 5. The destination identifier(s) take the form of pairs of telephone numbers associated with a recipient's fax number and a companion e-mail address associated with the same recipient. The e-mail addresses and fax numbers are stored in memory locations in the memory of the fax machine and are correlated to a particular actuator on the fax machine, such as a switch, button, or the like (as shown in step 10). This can be done in advance or at the time of sending the document to be transmitted. The user would then place the document to be transmitted in the fax machine's scanner and actuate the aforementioned actuator tied to the destination identifiers (i.e. recipient's fax telephone number and corresponding electronic mail address) (step 15). Preferably, this would entail depressing a single command button on the control panel of the fax machine. Upon pressing this command button, the fax machine initiates scanning of the document (if it has not already done so) and reads the destination identifier information stored in fax machine's memory (step 20). Next the fax machine packages the scanned document with the appropriate destination identifiers (step 25) and faxes and emails the document to the telephone numbers and email addresses entered in memory (step 30) as will be discussed in the following paragraphs. The foregoing steps are preferably implemented in the facsimile machine via a firmware embodiment. However, if desired, it would also be possible to employ the fax machine's memory to store software instructions that would be retrieved by the CPU to perform these steps.

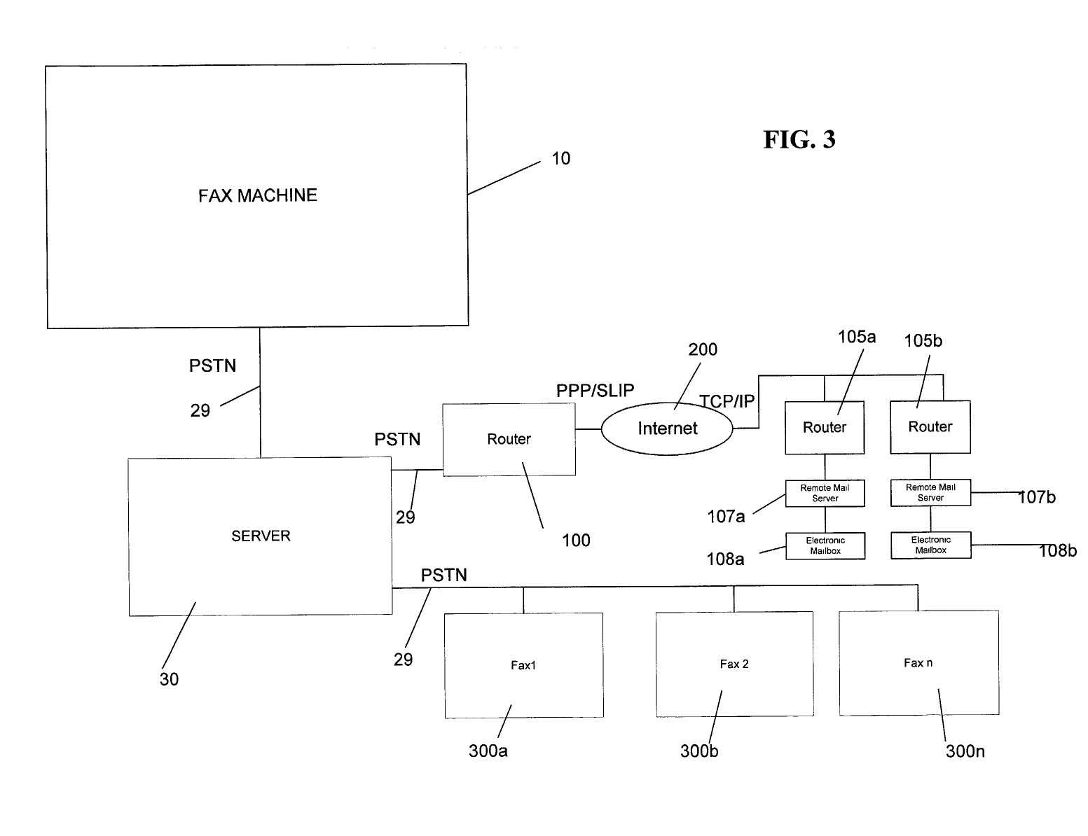

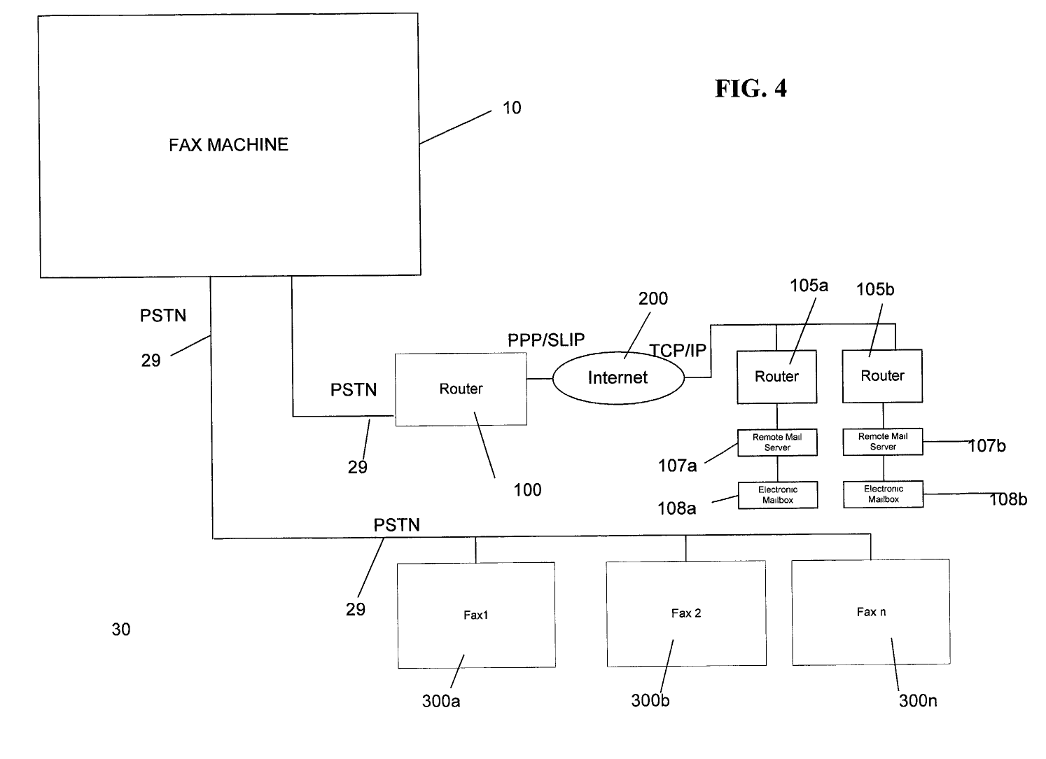

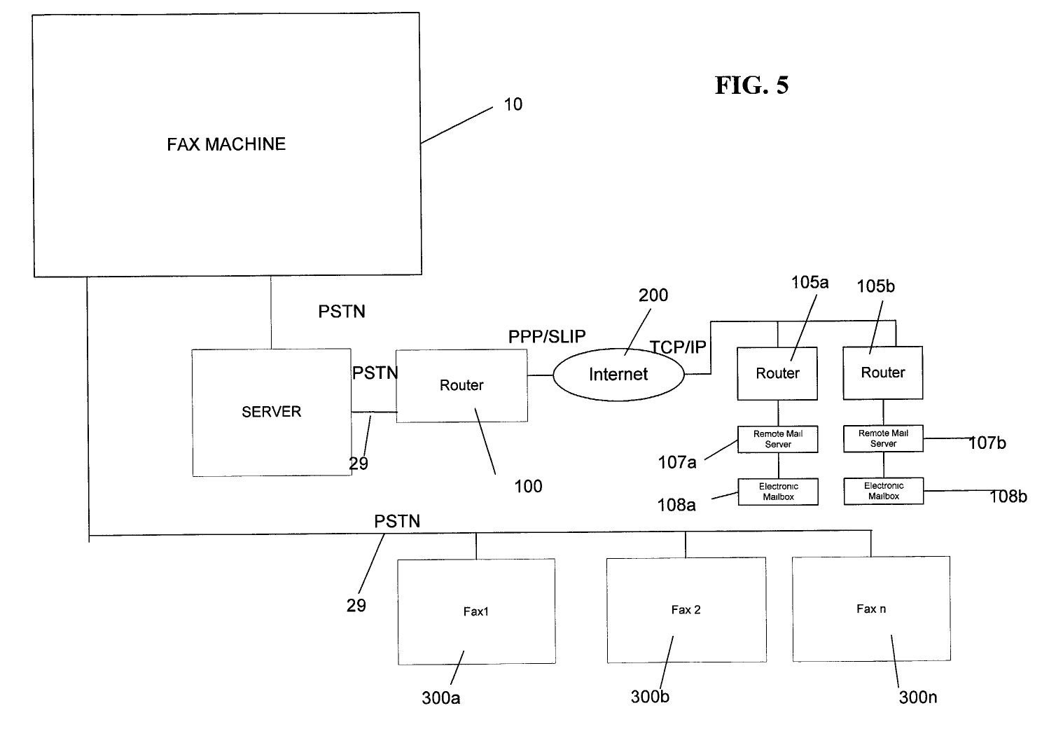

E-mails and faxes can be transmitted in a variety of ways. For instance, the fax machine could interface with both the Internet (or other wide area network (WAN)) and various other fax machines via a server, as shown in FIG. 3. The server 30 could consist of a PC or other computer, or a grouping of computers. The server 30 responds to requests and commands from the transmitting fax machine 10. Specifically, the server 30 receives the data message transmission from the fax machine 10 and decodes the data message to determine where to forward e-mail and fax message to the intended recipient. Alternately, the fax machine 10 could have a direct connection to both the Internet or other WAN and a separate connection to various fax machines, as shown in FIG. 4. Finally, the fax machine could have a direct connection to various other fax machines via phone lines but could interface with the Internet or other WAN via a server to send electronic mail, as shown in FIG. 5. These possibilities are explored more in depth below.

Referring again to FIG. 3, the aforementioned server 30 communicates in accordance with facsimile communications protocol over the Public Switched Telephone Network (PSTN) as discussed above. Electronic mail communications are performed between the server 30 and the telephone line 29 by establishing a communications link with router 100 which provides connection to the Internet 200 in order to transmit and receive information between the server 30 and the Internet 200. The router 100 typically transmits and receives electronic mail messages in accordance with the Simple Mail Transfer Protocol (SMTP). The functions performed by the routers 100, 105a and 105b may be performed by a commercial service which provides access to the Internet via dial-up connection. Remote mail servers, as seen at 107a-107b, each implement electronic mailboxes 108a-108b to receive electronic mail messages. Fax messages are transmitted from the server to various fax machines 300a-n via normal fax transmission methods.

Destination identifiers (fax telephone numbers and corresponding e-mail addresses) are entered and stored into the sending fax machine 10 by the user as described previously. Specifically, specialized data, which is based on data entered into the sending fax device by the user, is transferred from this fax device to the server in the fax transmission. In the preferred embodiment, the fax device should be able to support fax Binary File Transfer (BFT) capabilities. This capability will allow various data demarcated by tags to be entered into the message that is transmitted from the fax device to the server. Such tagged data would at a minimum include an e-mail address or addresses and corresponding fax telephone numbers.

The server deciphers the destination identifiers, strips them away, and forwards the remaining message data in the proper format to the appropriate fax and e-mail recipients. This process of sending fax and electronic mail from a fax machine via a server is provided in co-pending U.S. application entitled SYSTEM AND PROCESS FOR TRANSMITTING ELECTRONIC MAIL USING A CONVENTIONAL FACSIMILE DEVICE TITLE having Ser. No. ______ and a filing date of ______, the disclosure of which is incorporated herein by reference.

FIG. 4 represents another means by which the fax machine discussed above could transmit data to both e-mail and fax recipients. In this embodiment the fax machine transmits and receives information in accordance with both facsimile and electronic mail communications protocols. The fax device recognizes the destination identifiers, identifying a remote communications device as either a facsimile device or an e-mail device, and transmits a document in accordance with the communications protocol utilized by the identified device. This embodiment requires that the fax machine has a connection to the Internet or other network. Processing with respect to sending faxes to other facsimile machines is handled by conventional fax methods.

FIG. 5 represents still another method by which the fax machine 10 discussed above could transmit data to both e-mail and fax recipients. In this embodiment the server 30 performs only the functions associated with sending electronic mail as discussed above in the first embodiment. The facsimile transmission is handled directly by the fax machine. In this embodiment the fax machine 10 has a direct connection to the PSTN 29 and transmits faxes to various fax machines 300a-n by way of conventional fax methods.

While the invention has been described in detail by specific reference to preferred embodiments thereof, it is understood that variations and modifications thereof may be made without departing from the true spirit and scope of the invention.

Wherefore, having thus described the present invention, what is claimed is:

1. A process for sending electronic mail and facsimiles from a facsimile machine comprising the steps of:
a user entering into the facsimile machine a facsimile telephone number and an electronic mail address corresponding to a same recipient;
the user placing a document to be transmitted into a facsimile machine;
the fax machine storing the facsimile telephone number and electronic mail address in a memory location in a memory of the facsimile machine;
associating an actuator disposed on the facsimile machine to the memory location containing the facsimile telephone number and electronic mail address; and
the user activating said actuator to transmit a facsimile to the facsimile telephone number and electronic mail to the electronic mail address.

2. The process of claim 1, wherein the actuator comprises one of (i) a button, or (ii) a switch.

3. The process of claim 1, further comprising a step of transmitting at least one of (i) the facsimile and (ii) the electronic mail to the recipient via a server.

4. The process of claim 3, wherein the facsimile machine comprises a PSTN connection, and wherein only the electronic mail is transmitted via the server, whereas the facsimile is transmitted directly to the recipient via the PSTN connection.

5. The process of claim 3, wherein the step of transmitting at least one of (i) the facsimile and (ii) the electronic mail to the recipient via the server comprises the steps of the facsimile machine:
scanning the document to be transmitted and formatting message data derived from the scanned document;
appending standard facsimile formatting information, and the user-specified information comprising the facsimile telephone number and electronic mail address, to the formatted message data; and
transferring the formatted message data and appended information to the server.

6. The process of claim 5, further comprising the steps of the server:
receiving the appended information and message data from the facsimile machine;
extracting the facsimile telephone number from the user-specified information;
transmitting the message data with the formatting data to a facsimile device associated with the facsimile telephone number;
extracting the electronic mail address from the user-specified information;
stripping the appended information from the message data;
applying a standard electronic mail header to the message data; and,
transmitting the message data with its applied electronic mail header to an electronic mail mailbox associated with the electronic mail address extracted from the user-specified information.

7. The process of claim 1, wherein the facsimile machine comprises a PSTN connection and a connection to a wide area network, and wherein the process further comprises the steps of:
transmitting the facsimile via the PSTN connection; and
transmitting the electronic mail via the connection to the wide area network.

8. A system for sending electronic mail and facsimiles from a facsimile machine, comprising:
a computing device resident in the facsimile machine; and
a computer program comprising program modules executable by the computing device, wherein the computing device is directed by the computer program modules to,
store a facsimile telephone number and electronic mail address corresponding to a same recipient in a memory location in a memory of the facsimile machine, said number and address having been previously entered by a user,
associate an actuator disposed on the facsimile machine to the memory location containing the facsimile telephone number and electronic mail address, and
transmit a facsimile of a document placed into the facsimile machine by the user to the facsimile telephone number, and an electronic mail version of the document to the electronic mail address, upon activation of the actuator by the user.

9. The system of claim 8, wherein the actuator comprises one of (i) a button, or (ii) a switch.

10. The system of claim 8, wherein the transmitting program module comprises a sub-module for transmitting at least one of (i) the facsimile and (ii) the electronic mail to the recipient via a server.

11. The system of claim 10, wherein the facsimile machine comprises a PSTN connection, and wherein the sub-module for transmitting via the server comprises only transmitting the electronic mail via the server, and transmitting the facsimile directly to the recipient via the PSTN connection.

12. The system of claim 10, wherein the sub-module for transmitting at least one of (i) the facsimile and (ii) the electronic mail to the recipient via the server comprises sub-modules for:
scanning the document to be transmitted and formatting message data derived from the scanned document;
appending standard facsimile formatting information, and the user-specified information comprising the facsimile telephone number and electronic mail address, to the formatted message data; and
transferring the formatted message data and appended information to the server.

13. The system of claim 8, wherein the facsimile machine comprises a PSTN connection and a connection to a wide area network, and wherein the program module for transmitting comprises sub-modules for:
transmitting the facsimile via the PSTN connection; and
transmitting the electronic mail via the connection to the wide area network.

14. A computer-readable memory for sending electronic mail and facsimiles from a facsimile machine, comprising:
a computer-readable storage medium; and
a computer program comprising program modules stored in the storage medium, wherein the storage medium is so configured by the computer program that it causes a computing device resident in the facsimile machine to,
store a facsimile telephone number and electronic mail address corresponding to a same recipient in a memory location in a memory of the facsimile machine, said number and address having been previously entered by a user,
associate an actuator disposed on the facsimile machine to the memory location containing the facsimile telephone number and electronic mail address, and
transmit a facsimile of a document placed into the facsimile machine by the user to the facsimile telephone number, and an electronic mail version of the document to the electronic mail address, upon activation of the actuator by the user.

15. The computer-readable memory of claim 14, wherein the transmitting program module comprises a sub-module for transmitting at least one of (i) the facsimile and (ii) the electronic mail to the recipient via a server.

16. The computer-readable memory of claim 15, wherein the facsimile machine comprises a PSTN connection, and wherein the sub-module for transmitting via the server comprises only transmitting the electronic mail via the server, and transmitting the facsimile directly to the recipient via the PSTN connection.

17. The computer-readable memory of claim 15, wherein the sub-module for transmitting at least one of (i) the facsimile and (ii) the electronic mail to the recipient via the server comprises sub-modules for:
scanning the document to be transmitted and formatting message data derived from the scanned document;
appending standard facsimile formatting information, and user-specified information comprising the facsimile telephone number and electronic mail address, to the formatted message data; and
transferring the formatted message data and appended information to the server.

18. The computer-readable memory of claim 14, wherein the facsimile machine comprises a PSTN connection and a connection to a wide area network, and wherein the program module for transmitting comprises sub-modules for:
transmitting the facsimile via the PSTN connection; and
transmitting the electronic mail via the connection to the wide area network.
